(19) United States
(12) Patent Application Publication
(10) Pub. No.: US 2009/0052039 A1
(43) Pub. Date: Feb. 26, 2009

(54) OPTICAL DEVICE

(75) Inventors: Yuko YOKOYAMA, Saitama (JP); Masao TAKAHASHI, Tokyo (JP); Satoshi KARASAWA, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/192,329

(22) Filed: Aug. 15, 2008

(30) Foreign Application Priority Data
Aug. 24, 2007 (JP) 2007-218040

(51) Int. Cl. G02B 5/18

(52) U.S. Cl. 359/566

(57) ABSTRACT

An optical device comprises a first optical system, a second optical system, a shading unit, and a diffraction grating. The first optical system transforms incident light to parallel light. The second optical system transforms incident light to parallel light. An optical axis of the second optical system is different from an optical axis of the first optical system. The shading unit has transmission areas having slit forms and shading areas having strip forms. The transmission areas and the shading areas are alternately arranged. The diffraction grating deflects the light transmitted by the transmission areas in a predetermined direction. Part of the incident light through the first optical system passes through the transmission areas, and the rest are shaded by the shading areas. Part of the incident light through the second optical system passes through the transmission areas, and the rest are shaded by the shading areas.

### BACKGROUND OF THE INVENTION

1. Field of the Invention

The present invention relates to an optical device and in particular, to an optical device in which images based on light arriving from two directions can be observed simultaneously.

2. Description of the Related Art

An optical device in which one of the images based on light arriving from either of two directions may be selected and observed is proposed.

Japanese unexamined patent publication (KOKAI) No. 2005-31468 discloses a photographing apparatus whose field of view can be changed so that one of two images based on the selected incident light can be observed.

However, in that photographing apparatus, the two images based on the two incident lights can not be observed simultaneously.

### SUMMARY OF THE INVENTION

Therefore, an object of the present invention is to provide an optical device in which two images based on light arriving from two directions can be observed simultaneously.

According to the present invention, an optical device comprises a first optical system, a second optical system, a shading unit, and a diffraction grating. The first optical system transforms incident light to parallel light. The second optical system transforms incident light to parallel light. An optical axis of the second optical system is different from an optical axis of the first optical system. The shading unit has transmission areas having slit forms and shading areas having strip forms. The transmission areas and the shading areas are alternately arranged. The diffraction grating deflects the light transmitted by the transmission areas in a predetermined direction. Part of the incident light through the first optical system passes through the transmission areas, and the rest are shaded by the shading areas. Part of the incident light through the second optical system passes through the transmission areas, and the rest are shaded by the shading areas.

### BRIEF DESCRIPTION OF THE DRAWINGS

The objects and advantages of the present invention will be better understood from the following description, with reference to the accompanying drawings in which:

FIG. 1 is a construction diagram of an endoscope system;

FIG. 2 is a construction diagram of a tip of an electronic scope, viewed from an upper side;

FIG. 3 is a construction diagram of the tip of the electronic scope, viewed from a front side;

FIG. 4 shows the positional relationship between the front-view incident areas and the side-view incident areas of the imaging sensor; and

FIG. 5 shows a positional relationship between the first and second incident surfaces of the diffraction grating 17, the front-view objective lens, and the side-view objective lens.

### DESCRIPTION OF THE PREFERRED EMBODIMENTS

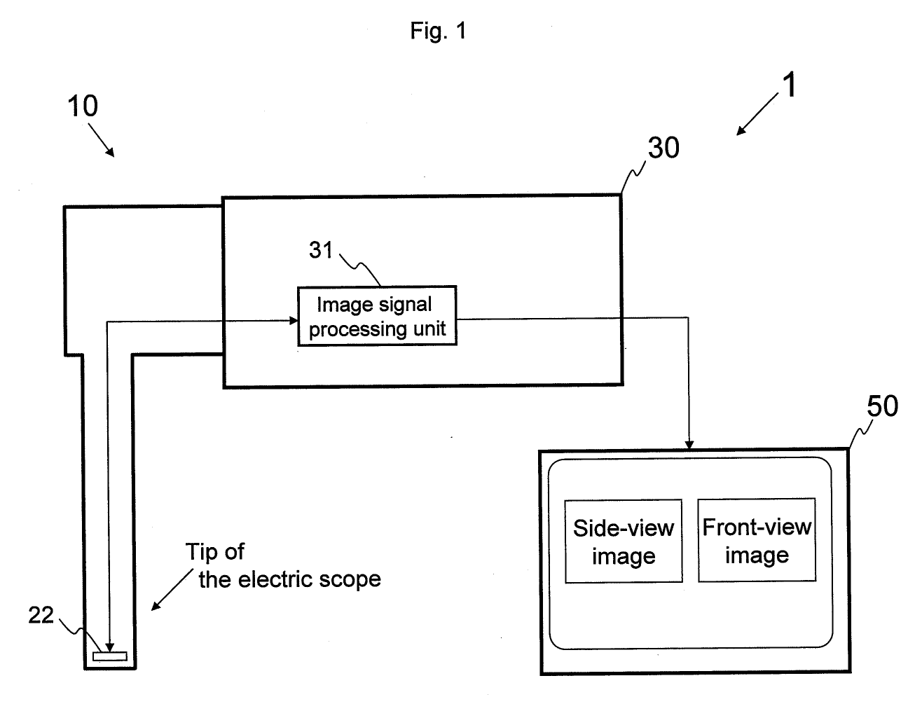

The present invention is described below with reference to an embodiment shown in the drawings. As shown in FIG. 1, an endoscope system 1 in the embodiment comprises an electronic scope 10, an image processor 30, and a monitor 50.

An imaging unit 22 of the electronic scope 10 captures an image and outputs an image signal based on the image to the image processor 30. An image-processing operation is carried out on the image signal by an image signal-processing unit 31 of the image processor 30 so as to display on the monitor 50.

In the endoscope system 1 in the embodiment, an operator can simultaneously observe a front view of the light arriving from the front face of the tip of the electronic scope 10, (in other words, the incident light along an insertion direction of the electronic scope 10) as well as a side view of the light arriving from a side face of the tip of the electronic scope 10.

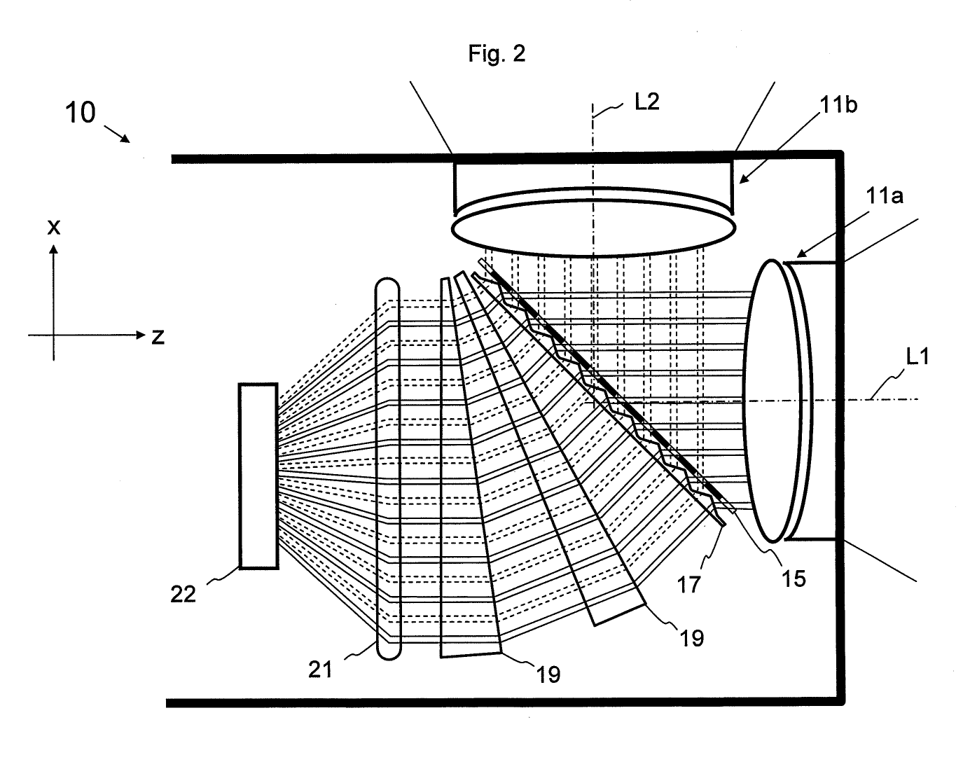

For the purposes of orientation in the embodiment, a first direction x, a second direction y, and a third direction z are defined (see FIGS. 2 to 5). The first direction x is the horizontal direction perpendicular to a first optical axis L1 of a front-view objective optical lens (a first optical system) 11a. The first direction x is parallel to a second optical axis L2 of a side-view objective optical lens (a second optical system) 11b. The second direction y is the vertical direction perpendicular to the first optical axis L1 and the first direction x. The third direction z is the horizontal direction parallel to the first optical axis L1 and perpendicular to both the first direction x and the second direction y.

The imaging part of the electronic scope 10 has a front-view objective lens 11a, a side-view objective lens 11b, a shading board (a grid) 15, a diffraction grating 17, a prism 19, a condenser lens 21, and an imaging unit 22 including a CCD or other imaging sensor.

The imaging unit 22 installed at the tip of the electronic scope 10 captures an image of the photographic subject e.g. body. The photographic subject is illuminated by light emitted from an illumination unit (not depicted).

The front-view objective lens 11a is attached to the front face of the tip of the electronic scope 10 and is a collimating lens that transforms front-view incident light to parallel light.

The side-view objective lens 11b is attached to the side face of the tip of the electronic scope 10 and is a collimating lens that transforms side-view incident light to parallel light.

The shading board 15 is arranged such that the center of its light-receiving area is located at the vicinity of the point at which the first axis L1 and the second axis L2 cross and at which the optical distance between the shading board 15 and the front-view objective lens 11a is almost the same as the optical distance between the shading board 15 and the side-view objective lens 11b.

The incident surface and output surface of the shading board 15 intersect the first direction x at 45 degrees.

Further, each surface of the shading board 15 intersects the third direction z at 45 degrees.

The front-view objective lens 11a and the side-view objective lens 11b have the same optical characteristics. Accordingly, the magnification and the like of the front-view photographic subject is equivalent to that of the side-view.

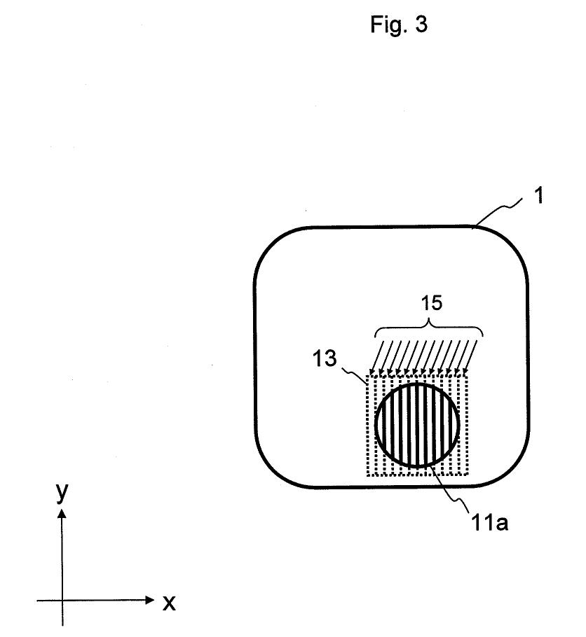

The shading board 15 has transmission areas having slit forms parallel to the second direction y and shading areas having strip forms parallel to the second direction y. The transmission areas and shading areas are alternately arranged. In FIG. 3, the part of the shading board 15 visible from the front through the front-view objective lens 11a is shown in solid lines and the hidden part of the shading board 15 from the same perspective is shown in dotted lines.

Part of the incident light through the front-view objective lens 11a passes through the transmission areas of the shading board 15 and reaches a first incident surface 17a of the diffraction grating 17 (the front-view; see double solid lines in FIG. 2). The rest is shaded by the shading areas of the shading board 15 and does not reach the diffraction grating 17.

Part of the incident light through the side-view objective lens 11b passes through the transmission areas of the shading board 15 and reaches a second incident surface 17b of the diffraction grating 17 (the side-view; see double broken lines in FIG. 2). The rest is shaded by the shading areas of the shading board 15 and does not reach the diffraction grating 17.

The incident light through the front-view objective lens 11a and the side-view objective lens 11b do not reach the same area of the diffraction grating 17, because they are blocked by the shading areas of the shading board 15. Namely, the shading areas of the shading board 15 prevent interference between the incident light through the front-view objective lens 11a and the incident light through the side-view objective lens 11b.

The diffraction grating 17 has a first incident surface 17a that faces the front-view objective lens 11a and a second incident surface 17b that faces the side-view objective lens 11b. The diffraction grating 17 deflects the light transmitted by the transmission areas of the shading board 15 in a predetermined direction.

Specifically, the diffraction grating 17 is arranged such that each the first direction x and the third direction z intersects the output surface of the diffraction grating 17 at 45 degrees. In other words, each the first optical axis L1 and the second optical axis L2 intersects the output surface of the diffraction grating 17 at 45 degrees.

The diffraction grating 17 deflects the light passing through the front-view objective lens 11a and the shading board 15 in a direction perpendicular to the incident surface of the shading board 15.

Similarly, the diffraction grating 17 deflects the light passing through the side-view objective lens 11b and the shading board 15 in the direction perpendicular to the incident surface of the shading board 15.

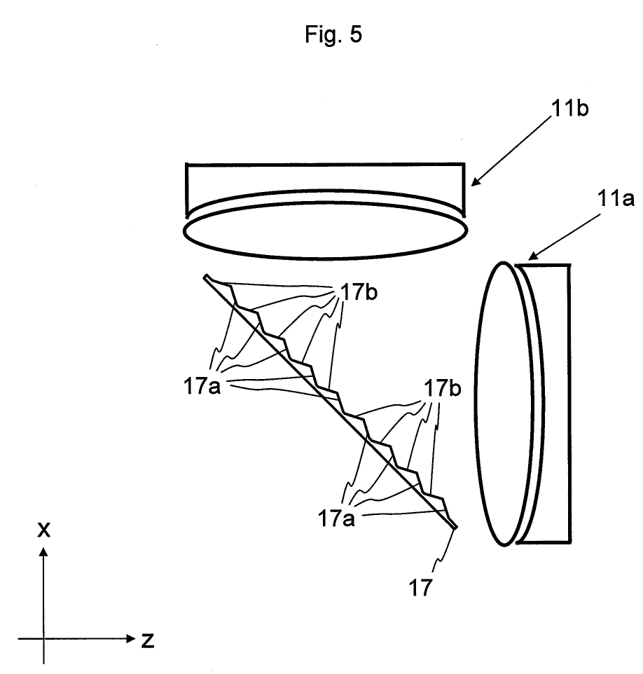

In order to show the positional relationship between the first incident surface 17a, the second incident surface 17b, the front-view objective lens 11a, and the side-view objective lens 11b, the other parts are omitted from FIG. 5.

The light output from the diffraction grating 17 is refracted by the prism 19, and condensed on the imaging surface of the imaging sensor of the imaging unit 22 by the condenser lens 21.

The imaging sensor of the imaging unit 22 captures the front-view incident light and the side-view incident light. Each of the incident lights is deflected by the diffraction grating 17 in the predetermined direction.

The imaging surface of the imaging unit 22 receives the front-view incident light and the side-view incident light, under the condition that the light from both sources is alternately arranged in the first direction x.

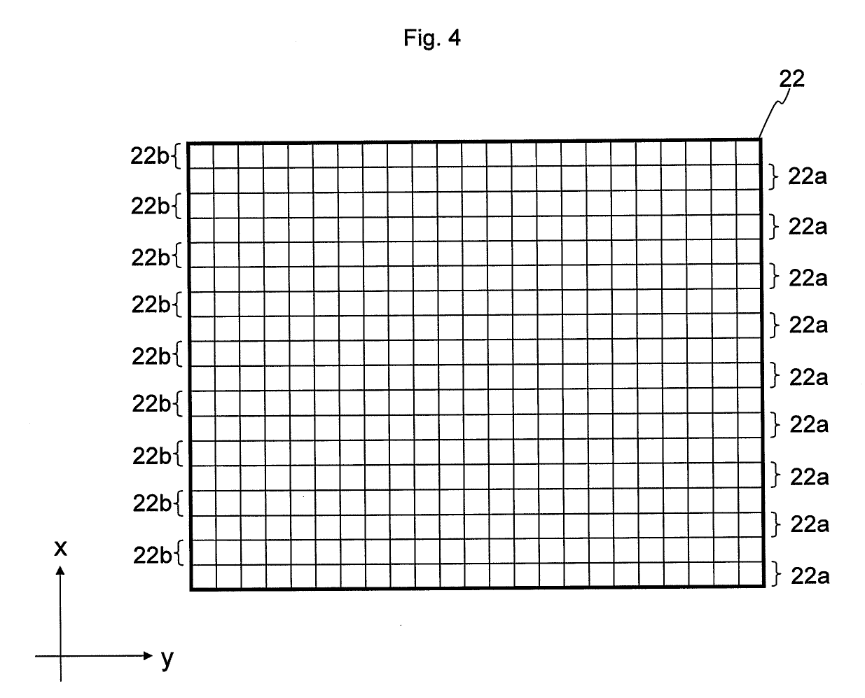

Areas of the imaging surface of the imaging unit 22 that receive the front-view incident light are defined as front-view capturing areas 22a while others that receive the side-view incident light are defined as side-view capturing areas 22b. The front-view capturing areas 22a and the side-view capturing areas 22b are alternately arranged in the first direction x (see FIG. 4).

The image signal-processing unit 31 performs the image-processing operation to generate a front-view image on the basis of a front-view image signal obtained by the front-view capturing areas 22a, as well as a side-view image on the basis of a side-view image signal obtained by the side-view capturing areas 22b.

Specifically, the image signal-processing unit 31 divides the image signal output from the imaging unit 22 into the front-view image signal and the side-view image signal, rearranges the front-view image signal to generate the front-view image, and rearranges the side-view image signal to generate the side-view image.

After the image-processing operation, the front-view image and the side-view image are displayed on the monitor 50 simultaneously.

In order to accurately divide the image signal into the front-view image signal and the side-view image signal, it is necessary to suitably choose the number of pixel rows n of the imaging sensor of the imaging unit 22 to designate to each of the front-view capturing areas 22a and the side-view capturing areas 22b in the first direction x, where n is small, the front-view image and the side-view image will be highly resolved.

In other words, it is desirable that a predetermined number of rows of pixels of the imaging sensor of the imaging unit 22 are arranged in each of the front-view capturing areas 22a in the first direction x, and in each of the side-view capturing areas 22b in the first direction x.

FIG. 4 shows the case that n is equal to 1, in other words, one row of pixels of the imaging sensor is designated to each of the front-view capturing areas 22a in the first direction x, and in each of the side-view capturing areas 22b in the first direction x.

The crossing point between the first optical axis L1 and the second optical axis L2 is in the vicinity of the center of the incident area of the shading board 15 and the center of the incident area of the diffraction grating 17.

The light path of the front-view incident light from the front-view objective lens 11a to the shading board 15 and the light path of the side-view incident light from the side-view objective lens 11b to the shading board 15 are axisymmetrical to the normal line of the incident surface of the shading board 15.

Furthermore, the shading board 15 and the diffraction grating 17 are arranged where they intersect both the first optical axis L1 and the second optical axis L2 at 45 degrees.

Therefore, the aforementioned arrangement enables to align the direction of the light path of the front-view incident light after deflection by the diffraction grating 17 with the direction of the light path of the side-view incident light after deflection by the diffraction grating 17 within just the minimum arrangement space regarding the diffraction grating 17 and the like.

In this embodiment, the front-view image and the side-view image can be observed simultaneously. Therefore, switching between the indication for the front-view image and the indication for the side-view image is not necessary.

The length of the light pass that passes through the vicinity of the apex of the prism 19 is different from the length of the light pass that passes through the vicinity of the bottom of the prism 19. This difference may degrade the image quality. However, because the difference is known beforehand, degradation of the image quality can be reduced by compensation in the image signal-processing unit 31.

In the case that this switching operation were performed by bending and stretching the tip of the electronic scope by using wire, the field of view might be varied due to the wire tension, and an appropriate insertion space for the electronic scope would be required to accommodate the bending.

However, in this embodiment, because the front-view observation and the side-view observation can be performed simultaneously, the construction of the tip of the electronic scope can be simplified and downsized compared to the case including mechanical parts such as a wire, etc. Furthermore, in the embodiment, the field of view is constant.

Furthermore, in this embodiment, the light refracted by the prism 19 is incident to the imaging surface of the imaging unit 22 that is perpendicular to the third direction z. The prism may be omitted. In this case, the imaging unit 22 would be located where the imaging surface of the imaging unit 22 is parallel to the incident surface of the shading board 15 (not depicted).

Furthermore, in this embodiment, the endoscope system 1 is used as the optical device, however, another apparatus may be used as the optical device.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2007-218040 (filed on Aug. 24, 2007) which is expressly incorporated herein by reference, in its entirety.

1. An optical device comprising:
a first optical system that transforms incident light to parallel light;
a second optical system that transforms incident light to parallel light, an optical axis of said second optical system being different from an optical axis of said first optical system;
a shading unit that has transmission areas having slit forms and shading areas having strip forms, said transmission areas and said shading areas being alternately arranged; and
a diffraction grating that deflects the light transmitted by said transmission areas in a predetermined direction;
part of the incident light through said first optical system passing through said transmission areas, and the rest being shaded by said shading areas;
part of the incident light through said second optical system passing through said transmission areas, and the rest being shaded by said shading areas.

2. The optical device according to claim 1, further comprising:
an imaging sensor that captures the light that is deflected by said diffraction grating in said predetermined direction; and
an image signal-processing unit that performs an image-processing operation to generate a first image on the basis of a first image signal obtained at first capturing areas, and to generate a second image on the basis of a second image signal obtained at second capturing areas, said first capturing areas being areas of an imaging surface of said imaging sensor that receives first incident light through said first optical system, said transmission areas, and said diffraction grating, said second capturing areas being areas of said imaging surface of said imaging sensor that receives second incident light through said second optical system, said transmission areas, and said diffraction grating, said first capturing areas and said second capturing areas being alternately arranged in an arrangement direction.

3. The optical device according to claim 2, wherein a predetermined number of rows of pixels of said imaging sensor are arranged in each of said first capturing areas in said arrangement direction, and in each of said second capturing areas in said arrangement direction.
